(19) United States
(12) Patent Application Publication
(10) Pub. No.: US 2009/0006076 A1
(43) Pub. Date: Jan. 1, 2009

(54) LANGUAGE TRANSLATION DURING A VOICE CALL

(76) Inventor: Dinesh K. Jindal, Naperville, IL (US)

Correspondence Address: DUFT BORNSEN & FISHMAN, LLP, 1526 SPRUCE STREET, SUITE 302, BOULDER, CO, 80302, US

(21) Appl. No.: 11/769,466

(22) Filed: Jun. 27, 2007

(51) Int. Cl. G06F 17/28

(52) U.S. Cl. 704/3

(57) ABSTRACT

Communication networks, communication devices, and associated methods are disclosed for translating voice communications for calls from one language to another. When a call is placed from a first party to a second party, the communication network receives voice communications for the call from the first party that are in a first language. The communication network identifies the first language of the first party and a second language of the second party. The communication network then translates the first party's voice communications in the first language to the second language, and transmits the first party's voice communications in the second language to the second party. The second party may listen to the first party's voice communications in the second language. The communication network also translates the second party's voice communications from the second language to the first language so that the first party may listen to the second party's voice communications.

### BACKGROUND OF THE INVENTION

1. Field of the Invention

The invention is related to the field of communications, in particular, to providing for language translation during an active voice call so that parties speaking different languages may have a conversation.

2. Statement of the Problem

It is sometimes the case that a calling party places a call to a called party that does not speak the same language as the calling party, such as when the call is placed to a foreign country. For instance, the calling party may speak English while the called party may speak French. When the parties to the call speak different languages, no meaningful conversation can take place. It may be possible with the proper planning before the call to use an interpreter to translate between the languages of the parties, but use of the interpreter may be inconvenient, may lengthen the time of the call, or may have other drawbacks. It is thus a problem for parties that speak different languages to communicate via a voice call.

### SUMMARY OF THE SOLUTION

Embodiments of the invention solve the above and other related problems by providing communication networks and/or communication devices that are adapted to translate voice communications for a call from one language to another in real time. For instance, if a calling party speaks English and a called party speaks French, then the communication network connecting the parties may translate voice communications from the calling party from English to French, and provide the voice communications to the called party in French. Also, the communication network may translate voice communications from the called party from French to English, and provide the voice communications to the calling party in English. The real-time voice translation as provided herein advantageously allows parties that speak different languages to have a meaningful conversation over a voice call.

In one embodiment, a communication network is adapted to translate voice communications for calls from one language to another. When a call is placed or initiated from a calling party to a called party, the communication network receives voice communications for the call from the calling party. The calling party's voice communications are in a first language, such as English. The communication network identifies the first language understood by the calling party, and identifies a second language understood by the called party. To identify the languages of the parties, the communication network may prompt the calling party and/or the called party for the languages, may receive indications of the languages in a signaling message for the call, may access a database having a pre-defined language indication for the parties, etc. The communication network then translates the calling party's voice communications in the first language to the second language understood by the called party, such as French. The communication network then transmits the calling party's voice communications in the second language to the called party. The called party may then listen to the calling party's voice communications in the second language.

The communication network also receives voice communications for the call from the called party for a full duplex call. The called party's voice communications are in the second language. The communication network translates the called party's voice communications in the second language to the first language. The communication network then transmits the called party's voice communications in the first language to the calling party, where the calling party may listen to the called party's voice communications in the first language.

In another embodiment, a communication device (e.g., a mobile phone) is adapted to translate voice communications for calls from one language to another. Assume for this embodiment that the communication device is being operated by a calling party initiating a call to a called party. The communication device receives voice communications for the call from the calling party, such as through a microphone or similar device. The calling party's voice communications are in a first language. The communication device identifies a second language for translation, such as a language understood by the called party, or a common language agreed upon. The communication device then translates the calling party's voice communications in the first language to the second language. The communication device provides the calling party's voice communications in the second language to the called party, such as by transmitting the calling party's voice communications in the second language over a communication network for receipt by the called party.

The communication device also receives voice communications for the call from the called party over the communication network. The called party's voice communications are in the second language. The communication device translates the called party's voice communications in the second language to the first language. The communication device then provides the called party's voice communications in the first language to the calling party, such as through a speaker. The calling party may then listen to the called party's voice communications in the first language.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIGS. 2-3 are flow charts illustrating methods of operating a communication network to translate voice communications for calls from one language to another in an exemplary embodiment of the invention.

FIG. 4 illustrates a communication device in an exemplary embodiment of the invention.

FIGS. 5-6 are flow charts illustrating methods of operating a communication device to translate voice communications for calls from one language to another in an exemplary embodiment of the invention.

### DETAILED DESCRIPTION OF THE INVENTION

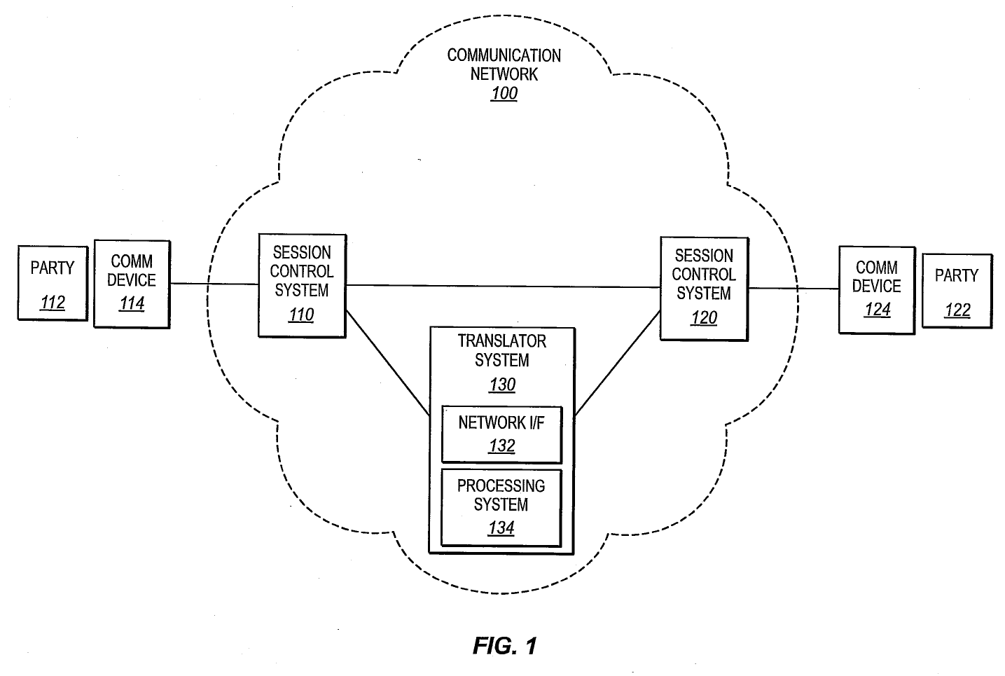

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a cellular network, an IMS network, a Push to Talk over Cellular (PoC), or another type of network. Communication network 100 includes a session control system 110 adapted to serve a communication device 114 of a party 112. Session control system 110 comprises any server, function, or other system adapted to serve calls or other communications from party 112. For example, in a cellular network, such as a CDMA or UMTS network, session control system 110 may comprise a MSC/VLR. In an IMS network, session control system 110 may comprise a Call Session Control Function (CSCF). Communication device 114 comprises any type of communication device adapted to place and receive voice calls, such as a cell phone, a PDA, a VoIP phone, or another type of device.

Communication network 100 further includes a session control system 120 adapted to serve a communication device 124 of a party 122. Session control system 120 comprises any server, function, or other system adapted to serve calls or other communications from party 122. Communication device 124 comprises any type of communication device adapted to place and receive voice calls, such as a cell phone, a PDA, a VoIP phone, or another type of device.

Although two session control systems 110, 120 are shown in FIG. 1, those skilled in the art understand that communication device 114 and communication device 124 may be served by the same session control system. Also, although session control systems 110 and 120 are shown as part of the same communication network 100, these two systems may be implemented in different networks possibly operated by different service providers. For instance, session control system 110 may be implemented in an IMS network while session control system 120 may be implemented in a CDMA network.

Communication network 100 further includes a translator system 130. Translator system 130 comprises any server, application, database, or system adapted to translate voice communications for calls from one language to another language in substantially real-time. Translator system 130 is illustrated in FIG. 1 as a stand alone system or server in communication network 100. In such an embodiment, translator system 130 includes a network interface 132 and a processing system 134. In other embodiments, translator system 130 may be implemented in existing facilities in communication network 100. As an example, if session control system 110 comprises a Central Office (CO) of a PSTN, then translator system 130 may be implemented in the CO. The functionality of translator system 130, which will be further described below, may be distributed among multiple facilities of communication network 100. As an example, some functions of translator system 130 may be performed by session control system 110 while other functions of translator system 130 may be performed by session control system 120.

Assume that party 112 wants to place a call to party 122, but that party 112 speaks a different language than party 122. For the below embodiment, party 112 is referred to as “calling party” and party 122 is referred to as “called party”. According to embodiments provided herein, a call may be established between a calling party 112 and a called party 122, and translator system 130 translates between the languages of calling party 112 and called party 122 during an active voice call as follows.

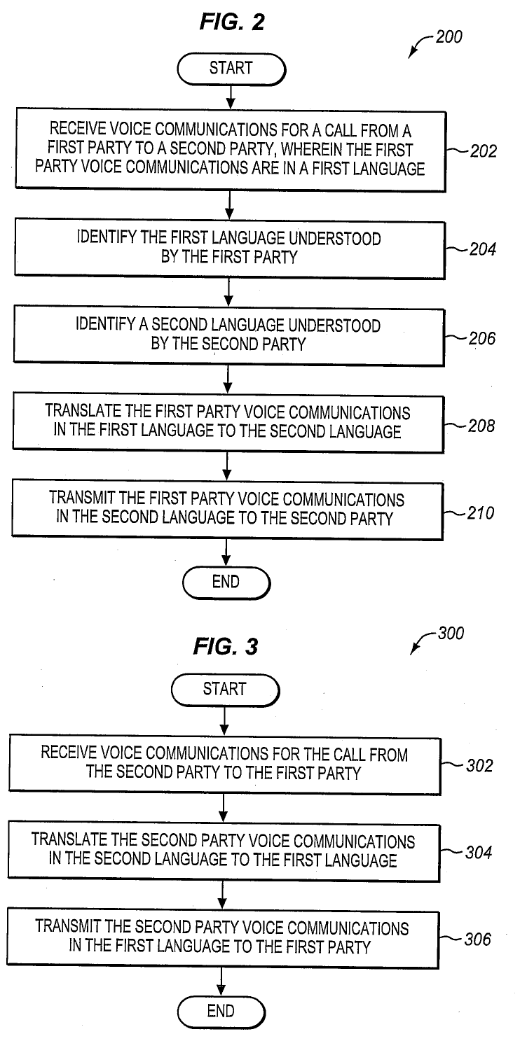

FIG. 2 is a flow chart illustrating a method 200 of operating communication network 100 to translate voice communications for calls from one language to another in an exemplary embodiment of the invention. The steps of method 200 will be described with reference to communication network 100 in FIG. 1. The steps of the flow chart in FIG. 2 are not all inclusive and may include other steps not shown. The steps of the flow chart are also not indicative of any particular order of operation, as the steps may be performed in an order different than that illustrated in FIG. 2.

In step 202 of method 200, translator system 130 receives voice communications for the call from calling party 112 through network interface 132. The voice communications from calling party 112 represent the segment or portion of the voice conversation as spoken by calling party 112. The voice communications from calling party 112 are in a first language, such as English.

In steps 204 and 206, processing system 134 of translator system 130 identifies the first language understood by calling party 112, and identifies a second language understood by called party 122. Processing system 134 may identify the languages of parties 112 and 122 in a variety of ways. In one example, processing system 134 may prompt calling party 112 and/or called party 122 for the languages spoken by each respective party. In another example, processing system 134 may receive indications of the languages in a signaling message for the call. Calling party 112 may enter a feature code or another type of input into communication device 114 indicating the languages of calling party 112 and/or called party 122 responsive to which communication device 114 transmits the language indications to translator system 130 in a signaling message. Calling party 112 may also program communication device 114 to automatically provide an indication of a preferred or understandable language to translator system 130 upon registration, upon initiation of a call, etc. In another example, processing system 134 may access a database having a pre-defined language indication for parties 112 and 122. Processing system 134 may identify the languages of parties 112 and 122 in other desired ways.

In step 208, processing system 134 translates the voice communications from calling party 112 in the first language to the second language that is understood by called party 122. As an example, processing system 134 may translate the voice communications from calling party 112 from English to French. Processing system 134 may store a library of language files and associated conversion or translation algorithms between the language files. Responsive to identifying the two languages of parties 112 and 122, processing system 134 may access the appropriate language files and appropriate conversion algorithm to translate the voice communications in substantially real-time during the call.

In step 210, network interface 132 transmits the voice communications for calling party 112 in the second language to called party 122. Called party 122 may then listen to the voice communications of calling party 112 in the second language instead of the first language originally spoken by calling party 112. Called party 122 can advantageously understand the spoken words of calling party 112 through the translation even though called party 122 does not speak the same language as calling party 112.

Because many voice calls are full duplex, translator system 130 is also adapted to translate voice communications from called party 122 in the second language to the first language understood by calling party 112. FIG. 3 is a flow chart illustrating a method 300 of operating communication network 100 to translate voice communications for calls from one language to another in an exemplary embodiment of the invention. The steps of method 300 will be described with reference to communication network 100 in FIG. 1. The steps of the flow chart in FIG. 3 are not all inclusive and may include other steps not shown.

In step 302 of method 300, network interface 132 of translator system 130 receives voice communications for the call from called party 122. The voice communications from called party 122 represent the segment or portion of the voice conversation as spoken by called party 122. The voice communications from called party 122 are in the second language, such as French. In step 304, processing system 134 translates the voice communications from called party 122 in the second language to the first language that is understood by calling party 112. As an example, processing system 134 may translate the voice communications from called party 122 from French to English. In step 306, network interface 132 transmits the voice communications for called party 122 in the first language to calling party 112. Calling party 112 may then listen to the voice communications of called party 122 in the first language instead of the second language originally spoken by called party 122. Calling party 112 can advantageously understand the spoken words of called party 122 through the translation even though calling party 112 does not speak the same language as called party 122.

As is illustrated in the above embodiment, parties 112 and 122 speaking different languages are able to effectively communicate over a voice call through translator system 130. Although the above embodiment illustrated a call between two parties, translator system 130 may translate between languages of three or more parties that are on a conference call. The translation in the above embodiment is accomplished through a network-based solution. However, the translation may additionally or alternatively be performed in communication device 114 and/or communication device 124. The following describes translation as performed in a communication device.

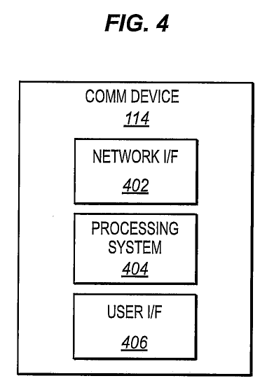

FIG. 4 illustrates a communication device 114 in an exemplary embodiment of the invention. Communication device 114 includes a network interface 402, a processing system 404, and a user interface 406. Network interface 402 comprises any components or systems adapted to communicate with communication network 100. Network interface 402 may comprise a wireline interface or a wireless interface. Processing system 404 comprises a processor or group of inter-operational processors adapted to operate according to a set of instructions. The instructions may be stored on a removable card or chip, such as a SIM card. User interface 406 comprises any components or systems adapted to receive input from a user, such as a microphone, a keypad, a pointing device, etc, and/or convey content to the user, such as a speaker, a display, etc. Although FIG. 4 illustrates communication device 114, communication device 124 may have a similar configuration.

Assume again that party 112 wants to place a call to party 122. According to embodiments provided herein, a call may be established between calling party 112 and called party 122, and communication device 114 translates between the languages of calling party 112 and called party 122 during an active voice call as follows.

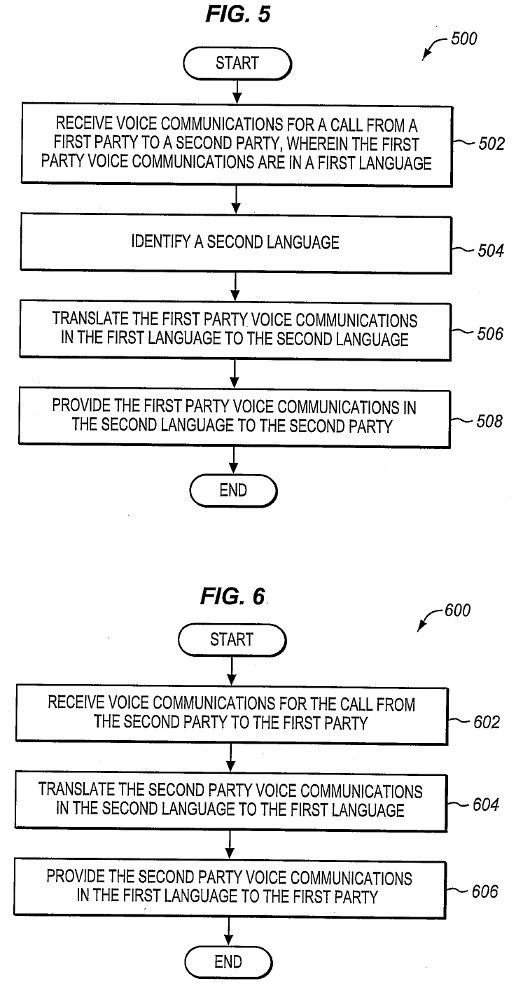

FIG. 5 is a flow chart illustrating a method 500 of operating communication device 114 to translate voice communications for calls from one language to another in an exemplary embodiment of the invention. The steps of method 500 will be described with reference to communication network 100 in FIG. 1 and communication device 114 in FIG. 4. The steps of the flow chart in FIG. 5 are not all inclusive and may include other steps not shown. The steps of the flow chart are also not indicative of any particular order of operation, as the steps may be performed in an order different than that illustrated in FIG. 5.

In step 502 of method 500, processing system 404 in communication device 114 receives voice communications for the call from calling party 112 through user interface 406. For instance, user interface 406 may be a microphone adapted to detect the audible voice frequencies of calling party 112. The voice communications from calling party 112 are in a first language. In step 504, processing system 404 identifies a second language of translation for the voice communications. The second language may be a language understood by called party 122, may be a pre-defined or common language, etc. Processing system 404 may identify the first language and/or second language in a variety of ways. In one example, processing system 404 may prompt calling party 112 for the languages spoken by each respective party. In another example, processing system 404 may receive input from calling party 112 indicating the languages of calling party 112 and/or called party 122. Processing system 404 may identify the languages of parties 112 and 122 in other desired ways.

In step 506, processing system 404 translates the voice communications from calling party 112 in the first language to the second language. Processing system 404 may store a library of language files and associated conversion or translation algorithms between the language files. Responsive to identifying the two languages of parties 112 and 122, processing system 404 may access the appropriate language files and appropriate conversion algorithm. Processing system 404 may then translate the voice communications in substantially real-time during the call.

In step 508, processing system 404 provides the voice communications for calling party 112 in the second language for receipt by called party 122. For instance, processing system 404 may transmit the voice communications over communication network 100 through network interface 402 to communication device 124 of called party 122. Called party 122 may then listen to the voice communications of calling party 112 in the second language instead of the first language originally spoken by calling party 112. Alternatively, communication device 124 may translate the voice communications in the second language to a third language understood by called party 122. Called party 122 can advantageously understand the spoken words of calling party 112 through the translation even though called party 122 does not speak the same language as calling party 112.

Communication device 114 is also adapted to translate voice communications from called party 122 in the second language to the first language understood by calling party 112. FIG. 6 is a flow chart illustrating a method 600 of operating communication device 114 to translate voice communications for calls from one language to another in an exemplary embodiment of the invention. The steps of method 600 will be described with reference to communication network 100 in FIG. 1 and communication device 114 in FIG. 4. The steps of the flow chart in FIG. 6 are not all inclusive and may include other steps not shown.

In step 602 of method 600, processing system 404 receives voice communications for the call through network interface 402 from called party 122. In step 604, processing system 404 translates the voice communications from called party 122 in the second language to the first language that is understood by calling party 112. In step 606, processing system 404 provides the voice communications for called party 122 in the first language to calling party 112. For instance, user interface 406 may comprise a speaker adapted to emit audible voice frequencies of called party 122 that may be heard by calling party 112. Calling party 112 may then listen to the voice communications of called party 122 in the first language instead of the second language originally spoken by called party 122. Calling party 112 can advantageously understand the spoken words of called party 122 through the translation even though calling party 112 does not speak the same language as called party 122.

Processing system 404 in communication device 114 (see FIG. 4) may not necessarily translate the voice communications from calling party 112 to a language that is understood by called party 122. Processing system 404 may convert the voice communications from calling party 112 to a pre-defined or common language and it is the responsibility of communication device 124 of called party 122 to convert the voice communications from the pre-defined language to the language understood by called party 122. For example, assume that calling party 112 speaks German and called party 122 speaks French. Processing system 404 of communication device 114 may translate the German speech of calling party 112 to English, and transmit the voice communications for calling party 112 in English. Communication device 124 of called party 122 would then receive the voice communications of calling party 112 in English. Because called party 122 understands French, communication device 124 would translate the voice communications from English to French.

Although the above description was in reference to communication device 114, communication device 124 of called party 122 may operate in a similar manner to translate received voice communications to a language understood by called party 122. Other communication devices not shown in FIG. 1 also may operate in a similar manner to translate the voice communications. For instance, this type of language translation may be beneficial in conference calls where there are three or more communication devices on a call. In a conference call scenario, a communication device of a first party may translate the voice communications from that party to a language pre-defined or agreed upon for the conference, or may convert the voice communications to a common language. For example, assume that a first party speaks German, a second party speaks English, and a third party speaks French. The communication device of the first party may translate voice communications from German to English, and transmit the voice communications to communication network 100. Similarly, the communication device of the third party may translate voice communications from French to English, and transmit the voice communications to communication network 100. The parties to the conference call may then be able to communicate because their communication devices converted the spoken languages to a common language, such as English.

### EXAMPLES

The following describes examples of translating voice communications for calls from one language to another. In FIG. 1, assume again that party 112 wants to place a call to party 122, but that party 112 speaks a different language than party 122. In this first example, communication network 100 provides the functionality to translate from one language to another. In other words, communication device 114 and/or communication device 124 may not need any special functionality to allow for language translation.

To place a call to called party 122, calling party 112 dials the number for called party 122 in communication device 114, selects called party 122 from a contact list, etc. Responsive to initiation of the call, communication device 114 generates a signaling message for the call, such as an SS7 Initial Address Message (IAM) or a SIP INVITE message, and transmits the signaling message to session control system 110. To instruct communication network 100 that a language translation is needed for this call, calling party 112 may enter a feature code, such as *91, into communication device 114. The feature code may additionally indicate one or more languages that will be involved in the translation. For instance, the feature code *91 may indicate an English to French translation is desired. In some real-life situations, especially in case of conference calls, we may just know the language of choice at each end-point. In such cases, the network will know the needed language conversion from each caller to each called party. Communication device 114 then transmits the feature code to session control system 110. Responsive to the receiving the feature code, session control system 110 notifies translator system 130 (which may actually be implemented in session control system 110) that voice communications for the call will need to be translated.

Responsive to the notification, translator system 130 identifies the first language understood by calling party 112, and identifies a second language understood by called party 122. In this example, translator system 130 identifies the first language of calling party 112 by prompting calling party 112. Translator system 130 may include an Interactive Voice Response (IVR) unit that provides a menu to calling party 112 requesting calling party 112 to select an understood language. In a similar manner, translator system 130 identifies the second language of called party 122 by prompting called party 122.

When the call is set up between calling party 112 and called party 122, assume that calling party 112 begins speaking into communication device 114. Communication device 114 detects the voice frequencies of calling party 112 and transmits voice communications for the call to session control system 110. Session control system 110 routes the voice communications from calling party 112 to translator system 130. Translator system 130 then translates the voice communications from calling party 112 in the first language to the second language that is understood by called party 122. Translator system 130 then transmits the voice communications for calling party 112 in the second language to called party 122. Translator system 130 performs this translation function in real-time during the active voice call. As a result, called party 122 listens to the voice communications of calling party 112 in the second language instead of the first language originally spoken by calling party 112. A similar process occurs to translate voice communications from called party 122 to calling party 112.

In a second example, assume again that party 112 wants to place a call to party 122. In this example, communication device 114 prompts calling party 112 for the languages to convert between, and communication network 100 provides the translation. Calling party 112 initiates the call to called party 122. Responsive to initiation of the call, communication device 114 prompts calling party 112 for the language in which calling party 112 will be speaking (the first language), and also prompts calling party 112 for the language of called party 122 (the second language), or in other words the language to which the voice communications will be translated. Communication device 114 then generates a signaling message for the call, and transmits the signaling message to session control system 110. The signaling message includes an indication of the first language and the second language. Responsive to the receiving the signaling message, session control system 110 transmits the indication of the first language and the second language to translator system 130. Translator system 130 is then able to identify the first language understood by calling party 112, and to identify the second language understood by called party 122 based on the indications provided in the signaling message.

When the call is then set up between calling party 112 and called party 122, assume that calling party 112 begins speaking into communication device 114. Communication device 114 detects the voice frequencies of calling party 112 and transmits voice communications for the call to session control system 110. Session control system 110 routes the voice communications from calling party 112 to translator system 130. Translator system 130 then translates the voice communications from calling party 112 in the first language to the second language that is understood by called party 122. Translator system 130 then transmits the voice communications for calling party 112 in the second language to called party 122. Translator system 130 performs this translation function in real-time during the active voice call. As a result, called party 122 listens to the voice communications of calling party 112 in the second language instead of the first language originally spoken by calling party 112. A similar process occurs to translate voice communications from called party 122 to calling party 112.

In a third example, assume again that party 112 wants to place a call to party 122. In this example, communication device 114 provides the functionality to translate from one language to another. Calling party 112 initiates the call to called party 122. Responsive to initiation of the call, communication device 114 prompts calling party 112 for the language in which calling party 112 will be speaking (the first language), and also prompts calling party 112 for the language of called party 122 (the second language). Communication device 114 then generates a signaling message for the call, and transmits the signaling message to session control system 110 to set up the call to called party 122. When the call is then set up between calling party 112 and called party 122, assume that calling party 112 begins speaking into communication device 114. Communication device 114 detects the voice frequencies of calling party 112 that represent the voice communications of calling party 112 that are in the first language. Communication device 114 translates the voice communications from calling party 112 in the first language to the second language that is understood by called party 122. Communication device 114 then transmits the voice communications for calling party 112 in the second language to called party 122 over communication network 100. Communication device 114 performs this translation function in real-time during the active voice call. As a result, called party 122 listens to the voice communications of calling party 112 in the second language instead of the first language originally spoken by calling party 112. A similar process occurs to translate voice communications from called party 122 to calling party 112.

In a fourth example, if a calling party 112 initiates the call to called party 122, then communication device 114 prompts calling party 112 for the language in which calling party 112 will be speaking (the first language). Communication device 114 also identifies a second language that is a common language agreed upon for transmission over communication network 100. For instance, the agreement may be to transmit voice communications in English over communication networks 100 in the United States. Communication device 114 then generates a signaling message for the call, and transmits the signaling message to session control system 110 to set up the call to called party 122. When the call is then set up between calling party 112 and called party 122, assume that calling party 112 begins speaking into communication device 114. Communication device 114 detects the voice frequencies of calling party 112 that represent the voice communications of calling party 112 that are in the first language. Communication device 114 translates the voice communications from calling party 112 in the first language to the second language. Communication device 114 then transmits the voice communications for calling party 112 in the second language over communication network 100.

Upon receipt of the voice communications in the second language, communication device 124 may provide the voice communications to called party 122 if they are in the appropriate language. However, if called party 122 does not speak the second language, then communication device 124 prompts called party 122 for the language in which called party 122 will be speaking (a third language). Communication device 124 then translates the voice communications from calling party 112 in the second language to the third language understood by called party 122. Communication device 124 then provides the voice communications calling party 112 in the third language, such as through a speaker.

A similar process occurs to translate voice communications from called party 122 to calling party 112.

Although specific embodiments were described herein, the scope of the invention is not limited to those specific embodiments. The scope of the invention is defined by the following claims and any equivalents thereof.

I claim:

1. A method of translating voice communications for calls from one language to another, the method comprising:
receiving voice communications for a call from a first party to a second party, wherein the first party voice communications are in a first language;
identifying the first language understood by the first party;
identifying a second language understood by the second party;
translating the first party voice communications in the first language to the second language; and
transmitting the first party voice communications in the second language to the second party to allow the second party to listen to the first party voice communications in the second language.

2. The method of claim 1 further comprising:
receiving voice communications for the call from the second party to the first party, wherein the second party voice communications are in the second language;
translating the second party voice communications in the second language to the first language; and
transmitting the second party voice communications in the first language to the first party to allow the first party to listen to the second party voice communications in the first language.

3. The method of claim 1 wherein identifying the first language understood by the first party and identifying a second language understood by the second party comprises:
receiving an indication of at least one of the first language and the second language from the first party in a signaling message for the call.

4. The method of claim 3 wherein receiving an indication of at least one of the first language and the second language from the first party in a signaling message for the call comprises:
receiving at least one feature code indicating the at least one of the first language and the second language.

5. The method of claim 1 wherein identifying the first language understood by the first party and identifying a second language understood by the second party comprises:
prompting the first party for an indication of at least one of the first language and the second language; and
receiving input from the first party indicating the at least one of the first language and the second language.

6. The method of claim 1 wherein identifying the first language understood by the first party and identifying a second language understood by the second party comprises:
prompting the first party for an indication of the first language;
receiving input from the first party indicating the first language;
prompting the second party for an indication of the second language;
receiving input from the second party indicating the second language.

7. The method of claim 1 wherein the method is performed in an IMS network.

8. The method of claim 1 wherein the method is performed in a cellular network.

9. A translator system adapted to translate voice communications for calls over a communication network from one language to another, the translator system comprising:
a network interface adapted to receive voice communications for a call from a first party to a second party, wherein the first party voice communications are in a first language; and
a processing system adapted to identify the first language understood by the first party, to identify a second language understood by the second party, and to translate the first party voice communications in the first language to the second language;
the network interface further adapted to transmit the first party voice communications in the second language to the second party to allow the second party to listen to the first party voice communications in the second language.

10. The translator system of claim 9 wherein:
the network interface is further adapted to receive voice communications for the call from the second party to the first party, wherein the second party voice communications are in the second language;
the processing system is further adapted to translate the second party voice communications in the second language to the first language; and
the network interface is further adapted to transmit the second party voice communications in the first language to the first party to allow the first party to listen to the second party voice communications in the first language.

11. The translator system of claim 9 wherein the processing system is further adapted to:
receive an indication of at least one of the first language and the second language from the first party in a signaling message for the call.

12. The translator system of claim 11 wherein the processing system is further adapted to:
receive at least one feature code indicating the at least one of the first language and the second language.

13. The translator system of claim 9 wherein the processing system is further adapted to:
prompt the first party for an indication of at least one of the first language and the second language; and
receive input from the first party indicating the at least one of the first language and the second language.

14. The translator system of claim 9 wherein the processing system is further adapted to:
prompt the first party for an indication of the first language;
receive input from the first party indicating the first language;
prompt the second party for an indication of the second language;
receive input from the second party indicating the second language.

15. The translator system of claim 9 wherein the communication network comprises an IMS network.

16. The translator system of claim 9 wherein the communication network comprises a cellular network.

17. A method of operating a communication device to translate voice communications for calls from one language to another, the method comprising:
receiving voice communications for a call from a first party to a second party, wherein the first party voice communications are in a first language;
identifying a second language for translation;
translating the first party voice communications in the first language to the second language; and
providing the first party voice communications in the second language over a communication network for receipt by the second party.

18. The method of claim 17 further comprising:
receiving voice communications for the call from the second party to the first party, wherein the second party voice communications are in the second language;
translating the second party voice communications in the second language to the first language; and
providing the second party voice communications in the first language to the first party to allow the first party to listen to the second party voice communications in the first language.

19. The method of claim 17 wherein identifying a second language comprises:
prompting the first party for an indication of the second language; and
receiving input from the first party indicating the second language.
